(19) United States
(12) Patent Application Publication
(10) Pub. No.: US 2025/0252446 A1
(43) Pub. Date: Aug. 7, 2025

(54) ARTIFICIAL INTELLIGENCE VIRTUAL ASSISTANT IN A PHYSICAL STORE

(71) Applicant: Loop Now Technologies, Inc., San Mateo, CA (US)

(72) Inventors: Jeremiah Kevin Tu, Sunnyvale, CA (US); Jing Xian Chen, Dublin, CA (US); Edwin Chiu, Cupertino, CA (US); Wu-Hsi Li, Somerville, MA (US); Jerry Ting Kwan Luk, Menlo Park, CA (US)

(73) Assignee: Loop Now Technologies, Inc.,, San Mateo, CA (US)

(21) Appl. No.: 19/188,053

(22) Filed: Apr. 24, 2025

Related U.S. Application Data
(63) Continuation-in-part of application No. 18/989,061, filed on Dec. 20, 2024.
Application No. 18/989,061 is a continuation-in-part of application No. 18/820,456, filed on Aug. 30, 2024.
Application No. 18/820,456 is a continuation-in-part of application No. 18/585,212, filed on Feb. 23, 2024.
(60) Provisional application No. 63/649,966, filed on May 21, 2024.
(60) Provisional application No. 63/638,476, filed on Apr. 25, 2024.
(60) Provisional application No. 63/571,732, filed on Mar. 29, 2024.
(60) Provisional application No. 63/557,622, filed on Feb. 26, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.

(51) Int. Cl. G06Q 30/015; G06Q 30/0601; G06T 13/40

(52) U.S. Cl. CPC G06Q 30/015; G06Q 30/0633; G06Q 30/0643; G06T 13/40

(57) ABSTRACT

Techniques for video processing using artificial intelligence are disclosed. An interactive video interface (IVF) located in a physical store is accessed. The IVF includes a video camera, interactive screen, and one or more microphones. The IVF includes a synthetic human that interacts with customers. A customer initiates an interaction with the IVF by standing within a minimum distance of the IVF, speaking to the IVF, interacting with the IVF screen, or scanning an identification card. The IVF collects input from the customer regarding products in the store. The IVF creates responses to the customer inquiries based on a large language model (LLM), including skills such as checking product inventory, recommending related products, completing ecommerce purchases, and coordinating product deliveries. The IVF produces a video segment featuring the response performed by the synthetic human. The IVF presents the video segment to the customer, including performing the selected skills.

### RELATED APPLICATIONS

This application claims the benefit of U.S. provisional patent applications “Artificial Intelligence Virtual Assistant In A Physical Store” Ser. No. 63/638,476, filed Apr. 25, 2024 and “Ecommerce Product Management Using Instant Messaging” Ser. No. 63/649,966, filed May 21, 2024.

This application is also a continuation-in-part of U.S. patent application “Artificial Intelligence Virtual Assistant Using Large Language Model Processing” Ser. No. 18/989,061, filed Dec. 20, 2024, which claims the benefit of U.S. provisional patent applications “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

The U.S. patent application “Artificial Intelligence Virtual Assistant Using Large Language Model Processing” Ser. No. 18/989,061, filed Dec. 20, 2024 is also a continuation-in-part of U.S. patent application “Livestream With Large Language Model Assist” Ser. No. 18/820,456, filed Aug. 30, 2024, which claims the benefit of U.S. provisional patent applications “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

The U.S. patent application “Livestream With Large Language Model Assist” Ser. No. 18/820,456, filed Aug. 30, 2024 is also a continuation-in-part of U.S. patent application “Synthesized Realistic Metahuman Short-Form Video” Ser. No. 18/585,212, filed Feb. 23, 2024, which claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video processing and more particularly to an artificial intelligence virtual assistant in a physical store.

### BACKGROUND

Humans have made remarkable strides and contributions in their time on the earth. They have learned to grow and cultivate plants of all sorts, from grasses and grains to fruits and berries. Crops, flowers, all manner of trees for food, wood products, and landscaping products are harvested on a daily basis. Animals have been tamed and managed across diverse ecological conditions on land; in the air; and in our oceans, lakes, and rivers. The materials of the earth itself have been harvested-stone for building; minerals for all sorts of purposes; and gems and metals for industry, for fashion, and as currency. We have built cities, roads, factories, ships, airplanes, submarines, skyscrapers, and rockets that can send astronauts to the moon. Artistic expression comes in all forms: music, painting, dance, sculpture, photography, film, television, theater, and architecture. People can work together in groups, collaborating across a table or across the globe. People can work alone, with access to resources as varied as our imagination can design and fabricate. We work and play, make war and peace, create and destroy, build and rebuild. We have explored the oceans, climbed mountains, crossed deserts, stood on both poles, and walked across continents.

Our complexity and worldwide diversity lead to tools and machines as varied as ourselves. There are over fifty kinds of hammers, thirty types of wrenches, and twenty sorts of screwdrivers. We have specialized tools for car engines, diesel engines, jet engines, steam engines, and electric motors. We have power saws, chain saws, power drills, nail guns, paint guns, power washers, and cordless sanders. Woodworking tools can barely be counted. We fashion materials into countless machines and parts for machines. We build ships to carry men and materials from one continent to another; planes to transport from one to over eight hundred people at a time; rockets to lift payloads large and small; satellites to oversee communications, watch the weather, track crops, and pinpoint our location. Nearly every machine we build acts to extend or amplify skills that have been developed for decades or even centuries by countless humans. Cloth once spun on a wheel or loom is now produced in vast quantities hundreds of times more quickly. Even so, the basic process of harvesting wool or cotton or silk, separating the fibers, spinning them together, and interweaving them at ninety-degree angles to one another remains the same. Cloth is dyed in much the same way it that it was thousands of years ago. Restaurants prepare cuisines that are as old as the history of man, and combine them in ways that surprise the eyes and the palates of patrons on a daily basis. The pots, pans, spoons, and knives used by the chefs are sometimes handed down across generations, and other times created by companies formed only weeks before. The skills we learn from our parents, siblings, schools, workgroups, and communities continue to evolve and grow as our world spins on. Accordingly, the tools we use to practice and refine these skills grow and evolve right along with them.

### SUMMARY

Store owners, clerks, and salespeople need a diverse set of skills in order to sell their wares and serve their customers. As customers increase, and their demands become more varied, the value of digital service and salespeople grows. Regardless of whether the interaction is in person or digital, a service or salesperson must know the product or service being discussed, know how to support it, and be able to communicate effectively with the customer. The required skillset varies from knowing the POS system, checking inventory, cross-selling related or alternate products, and arranging shipping. Knowing the customer, especially repeat customers, can be the difference between a sale and a lost opportunity. The relationship between the sales or support person and the customer must form quickly and engage the user in a positive manner. Understanding the subject and the tone of the conversation is vital to both maintaining the relationship and increasing the likelihood of a return customer. Listening to the customer so as to understand the information they need, addressing a customer's requirements effectively and efficiently, and presenting the answers accurately takes practice, even for professional sales and customer service staff members. The more quickly and reliably the correct information and sales tasks can be accessed and delivered in a manner that communicates understanding and respect to the customer, the better. As the global market continues to expand sales and support demand, strong sales and support outlets and delivery mechanisms must grow to meet the need.

Techniques for video processing using artificial intelligence are disclosed. An interactive video interface (IVF) located in a physical store is accessed. The IVF includes a video camera, an interactive screen, and one or more microphones. The IVF includes a synthetic human that interacts with customers. A customer initiates an interaction with the IVF by standing within a minimum distance, speaking to the IVF, interacting with the IVF screen, or scanning an identification card. The IVF collects input from the customer regarding products in the store. The IVF creates responses to the customer inquiries based on a large language model (LLM), including skills such as checking product inventory, recommending related products, completing ecommerce purchases, and coordinating product deliveries. The IVF produces a video segment featuring the response performed by the synthetic human. The IVF presents the video segment to the customer, including performing the selected skills.

A computer-implemented method for video processing is disclosed comprising: accessing, by a user, an interactive video interface (IVF), wherein the IVF includes a video camera and an interactive screen, wherein the IVF includes a synthetic human, and wherein the IVF is located in a physical store; collecting, by the IVF, user input, wherein the user input comprises an inquiry, wherein the inquiry is based on a product for sale; creating a response, by the IVF, wherein the response is based on a large language model (LLM), and wherein the response includes selecting, by the LLM, one or more skills, wherein the selecting is based on the creating; producing a video segment, wherein the video segment is based on the response, and wherein the video segment includes an animated performance by the synthetic human; and responding, by the synthetic human, to the inquiry, wherein the responding includes the video segment, and wherein the responding includes performing, by the IVF, the one or more skills that were selected. In embodiments, the one or more skills include a checkout function. In embodiments, the one or more skills include playing a short-form video relevant to the product for sale. In embodiments, the playing a short-form video includes enabling an ecommerce purchase of the product for sale. In embodiments, the ecommerce purchase includes a representation of the product for sale in an on-screen product card.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for an artificial intelligence virtual assistant in a physical store.

FIG. 2 is a flow diagram for performing an action.

FIG. 3 is an infographic for an artificial intelligence virtual assistant in a physical store.

FIG. 4 is an infographic for initiating an interaction.

FIG. 5 is an infographic for playing a short-form video.

FIG. 6 is an infographic for providing instructions.

FIG. 7 is an example of an ecommerce purchase.

FIG. 8 is a system diagram for an artificial intelligence virtual assistant in a physical store.

### DETAILED DESCRIPTION

The challenge of responding to customer questions and comments quickly and accurately can be difficult. Providing good customer service requires a broad set of skills, from completing a sale to showing alternative products. Accessing the right information quickly and presenting it to the customer in an engaging, friendly manner can be the difference between a sale or a potential customer leaving the store. Understanding the subtleties of conversations with users can be a challenge as well. Users can sometimes begin conversing about one thing and end up talking about something else. The conversation can sometimes start off calmly and can later become combative or confrontational. Understanding and responding to such changes effectively and efficiently can be enormously challenging, even for professional sales and support staff people. Large language models (LLMs) including natural language processing (NLP) can help by monitoring the user interactions and generating answers to questions as they arise in a conversation. Additional sales and support skills that can be maintained within the store or accessed from web-based partners can allow a digital host to be increasingly effective. As choices of digital options increase for sales and customer support, the uses of LLM s in an IVF can help encourage rapid and accurate viewer engagement, increased sales, and long-term customer/vendor relationships.

Techniques for video processing are disclosed. Users access an interactive video interface (IVF) placed in a physical store. The IVF includes a video camera and an interactive screen. The interactive screen comprises a touchscreen. The IVF includes a synthetic human that can interact with the user. The IVF collects user input that can comprise an inquiry based on one or more products for sale in the store. The user input can be collected by the video camera, one or more microphones, or text information typed into the interactive screen. User input regarding products can also be scanned in using a bar or UPC code scanner included in the IVF. Demographic data, sales history, purchase preferences, and other user information can be accessed by the IVF as the user is identified using facial scanning, voice matching, or text data typed into the interactive screen. One or more LLM s included in the IVF can analyze the user inquiry, look up related information in the LLM knowledgebase, access required skills to complete tasks related to the inquiry, and create a response to the user. The response can include text and actions for the synthetic human to perform; skills for the synthetic human to complete, including completing a sale, demonstrating a product, and presenting videos related to the product inquiry; and so on. The IVF produces a video segment of the synthetic human performing the response generated by the LLM, along with any related skills. The video segment is presented to the user on the interactive screen. The user can respond with additional inquiries, move on to a different product, give shipping information regarding the purchased product, and so on. The IVF can continue to collect user input and generate responses so that the interaction flows in a similar manner to an interaction with a human sales or support person.

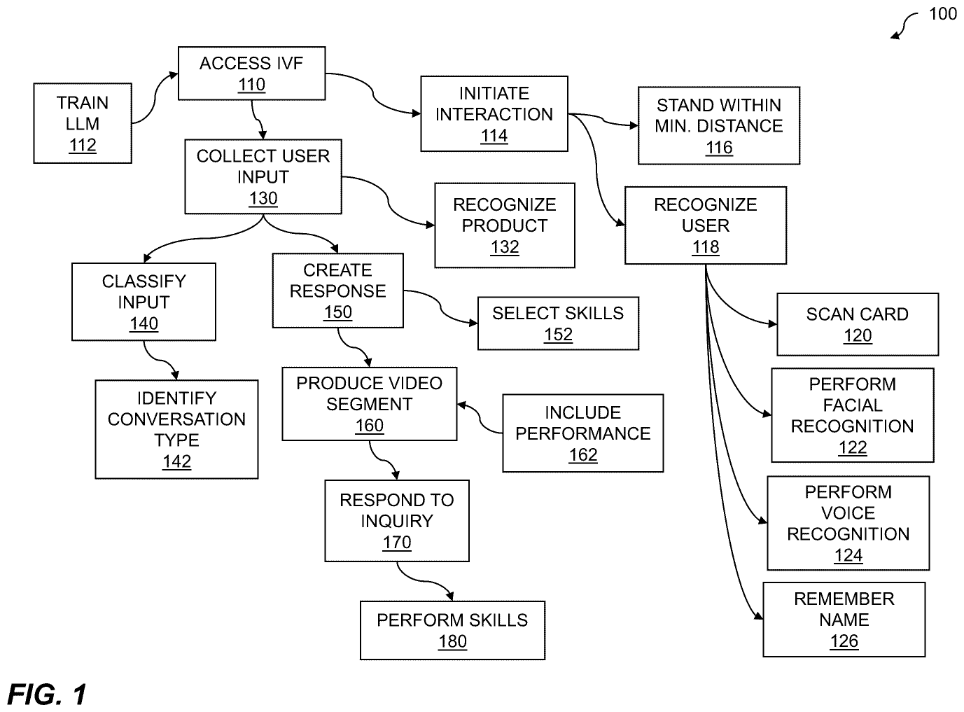

FIG. 1 is a flow diagram for an artificial intelligence virtual assistant in a physical store. The flow 100 includes accessing 110, by a user, an interactive video interface (IVF), wherein the IVF includes a video camera and an interactive screen, wherein the IVF includes a synthetic human, and wherein the IVF is located in a physical store. In embodiments, the interactive screen comprises a touchscreen. The IVF can include one or more microphones. The IVF can be a free-standing structure or can be attached to a wall included in the physical store. In some embodiments, a digital keyboard can be displayed on the interactive screen, as well as screen hotspots, to initiate an interaction. Stylus pens can be included to accommodate customers who prefer not to touch the interactive screen directly. In some embodiments, the ability to collect cash payments and provide change can be included. Magnetic card readers for ATM and credit card purchases, as well as a scanner for RFID transactions, can also be included.

In embodiments, the synthetic human can be based on an image of a live human. The synthetic human can be based on images captured from media sources including one or more photographs, videos, livestream events, and livestream replays. The voice of a human can be recorded and included in the synthetic human. The synthetic human can include a synthesized voice. In some embodiments, the appearance of the synthetic human can be customized, based on user information collected by the IVF. Elements of user demographic data, including sex, age, race, and so on, can be used to select and customize the appearance of the synthetic human. The synthetic human can be chosen to encourage the user to interact with the synthetic human and to be open to purchase products that are presented and discussed during the interaction. The customizing can include age, sex, race, hair color and style, clothing, accessories, facial hair, eyewear, and so on. In embodiments, the voice of the synthetic human can be customized, including the tone, pitch, accent, rhythm, and idioms. In some embodiments, the IVF customizes the voice and appearance of the synthetic human based on previous interactions with human and synthetic hosts of livestreams, sales associates, frequently watched social media influencers, and so on, as well as the demographics of the user.

In embodiments, the accessing further comprises training 112 an LLM, wherein the training is based on a private knowledgebase, wherein the private knowledgebase includes a plurality of details about the product for sale. In embodiments, the large language model is a type of machine learning model that can perform a variety of natural language tasks, including generating and classifying text, answering questions in a human conversational manner, and translating text from one language to another. The LLM can be trained 112 with voice and text interactions between users, human sales associates, help desk staff members, product experts, other Al virtual assistants, and so on. Information articles and questions covering products and services offered for sale by the store can be included in the LLM knowledgebase. A knowledgebase is a centralized collection of information about a specific topic or entity. In embodiments, the knowledgebase contains information related to products and services offered by a physical store, group of stores, warehouse, and so on. The knowledgebase can hold any type of information related to the products and services offered by the store. The data can include structured text, unstructured text, documents, videos, service or user manuals, sales fliers, brochures, short-form videos, video clips from websites, and so on. The information on products in the knowledgebase can be analyzed by the LLM and used to generate answers to questions and comments related to products and services offered for sale. In embodiments, the knowledgebase can include information or answers to common questions that have been entered by a seller, manufacturer, etc. of the product for sale.

In embodiments, one or more LLM s can be included in the IVF. The IVF can include one or more lightweight LLM s that can quickly classify a conversation with a user and forward the user data to a knowledge tree for additional classification or a selection of skills. A lightweight LLM is a language model that is designed to be compact, efficient, and low-latency while maintaining reasonable performance. They are useful for scenarios where real-time responsiveness is crucial. An additional LLM can be used to generate a response to the user that can include selected skills related to the user inquiry identified by the lightweight LLM. The additional LLM can be a heavy LLM. A heavy LLM can be a “high parameter space LLM.” A heavy LLM can create a response in one second or more. A heavy LLM is a large language model that is resource-intensive in terms of computational requirements and memory usage. Heavy LLM s are designed to handle complex language tasks, generate high-quality text, and achieve state-of-the-art performance. They are trained on massive datasets. Heavy LLM s are large in terms of model size. They are especially good at natural language processing (NLP) tasks such as language translation, summarization, and content generation. They also have the advantage of being able to adapt to specific applications based on domain-specific data. A heavy LLM can include more detailed information on products and services offered by the store, as well as details about the users.

In embodiments, the accessing further comprises initiating 114, by the user, an interaction with the IVF. The initiating can include standing 116, by the user, within a minimum distance from the IVF. In embodiments, the minimum distance can be six inches, twelve inches, or any other distance. The initiating can include recognizing 118 the user. In embodiments, the recognizing can be based on the video camera. The recognizing can include performing 122, by the IVF, facial recognition on the user. The facial recognition can include stored images of users that can be compared to images captured by the video camera. The recognizing can be based on data entered by the user on the interactive screen. The user can enter a username and password by typing the information into a physical keyboard or a digital keyboard displayed on the interactive screen. The recognizing can include scanning 120 an identification card. The identification card can include a barcode, an RFID chip, a magnetic strip, and so on. In embodiments, the identification card comprises a membership card, a driver's license, or another form of identification. The recognizing can include performing 124, by the IVF, voice recognition on the user, wherein the IVF includes a microphone. The LLM can include stored Mel spectrogram data for store customers. The stored Mel spectrogram data can be compared to audio data detected by the IVF microphone and used to analyze or recognize a user speaking, through the IVF, to known customers. The recognizing can include a purchase history. The recognizing can include one or more previous interactions with the IVF. The recognizing can further comprise remembering 126, by the IVF, a name of the user, wherein the name was saved in a previous inquiry. The recognizing can include preferred payment details, shipping addresses, clothing sizes, owned vehicle information, tire sizes, etc., based on information collected by the store as part of previous purchases or interactions.

The flow 100 includes collecting 130, by the IVF, user input, wherein the user input comprises an inquiry, wherein the inquiry is based on a product 132 for sale. In embodiments, the inquiry is based on one or more additional products for sale. The user input can comprise text. The user can respond to the synthetic human by typing a question or comment into a chat text box displayed on the interactive screen. The text box can be generated by the IVF. The user input can comprise audio input. The audio input can include speaking into one or more microphones included in the IVF. The audio input can be analyzed to collect one or more user signals. The user signals can include emotions and gestures of the user, purchase information, shipping information, demographics, and so on. The collecting can further comprise transforming the audio input into text, wherein the transforming is accomplished with a speech-to-text converter. The user input can comprise video input. The video input can be collected by the webcam included in the IVF. The video input can be analyzed to collect one or more user signals. The video input can include audio input which can be analyzed, recorded, and/or transformed by a speech-to-text converter.

In embodiments, the collecting includes classifying 140, by one or more lightweight LLMs, the user input, wherein the classifying identifies a type of conversation 142, wherein the classifying is based on the collecting, and wherein the responding is based on the type of conversation. A lightweight LLM is a language model that is designed to be compact, efficient, and low-latency while maintaining reasonable performance. They are useful for scenarios where real-time responsiveness is crucial. In embodiments, the one or more classifiers can comprise one or more sematic searches. A semantic search can understand a user's intent and take that into account in a search algorithm. A semantic search can provide data faster than a lightweight LLM, and thus can be useful to classify 140 user input and identify a type of conversation 142 the user wishes to have with the synthetic human. In embodiments, the one or more classifiers can include any combination of lightweight LLMs and semantic searches. The one or more classifiers, which can be a combination of lightweight LLMs and/or semantic searches, can run in parallel with the user input. Running multiple processes in parallel ensures that the classification of the user input can occur quickly.

User input can be forwarded to the one or more classifiers to determine the type of conversation 142 the user wishes to have with the synthetic human. In embodiments, the type of conversation includes a greeting. In other embodiments, the type of conversation includes an inquiry. In further embodiments, the type of conversation includes a chat, wherein the chat is not based on the one or more products for sale. In still other embodiments, the type of conversation includes a sentiment. In embodiments, the type of conversation includes a request for information. M any other types of conversations are possible. In practice, each classifier can search for a type of conversation in parallel so that all types of conversations can be identified concurrently, increasing the speed and accuracy of generating a response to the user.

The flow 100 includes creating 150 a response, by the IVF, wherein the response is based on a large language model (LLM), and wherein the response includes selecting 152, by the LLM, one or more skills, wherein the selecting is based on the creating. In embodiments, the LLM can be trained on product and service data related to items sold by store including the IVF. The product and service data can reside in a knowledge database that is accessible and updatable by a seller of the product or service. Additional training data can be provided by product vendor sites, product expert videos, marketing and advertising materials, sales staff input, and so on. Previous user interactions can also be included in the LLM training data, so that the LLM responses become increasingly tailored to the needs of users interacting with the IVF. In embodiments, the conversation module selected by the router can include all user input signals including the kind of information being sought and the general attitude of the user. The user information can be analyzed by the LLM to generate a response to the user that addresses both the emotional tone and the information-based aspects of the conversation between the user and synthetic human host. In embodiments, the LLM response can be a text file that includes instructions for the video production step, as well as the words to be spoken by the synthetic human.

In embodiments, the skills included in the IVF can be used to conduct tasks related to the user inquiry classified by the LLM. In some embodiments, the skills can be accessed through an application programming interface (API), wherein the API executes a web service. An API is a computer program that can apply a set of rules that allow two software applications to communicate with each other and exchange data. In embodiments, the skills can include initiating an ecommerce purchase, completing a purchase checkout, coordinating a delivery, sending a reminder, recommending related products, and so on.

The flow 100 includes producing 160 a video segment, wherein the video segment is based on the response, and wherein the video segment includes an animated performance 162 by the synthetic human. In embodiments, the text of the response to the user generated by the LLM is used to create a set of video clips including the synthesized human performing the response. The text response to the user can be used to create an audio stream using the voice of the synthesized human used in the first response to the user. The audio stream can be broken down into smaller segments based on natural language processing (NLP) analysis. Each audio segment can be used to produce a video clip of the synthesized human performing the audio segment. Based on the content of the audio, the synthesized human can hold up and demonstrate a product, show the product at different angles, describe various ways of using the product, place the product on the synthetic head or body (for example, if the product for sale is an article of clothing or accessory), and so on. The audio segments can be sent to multiple processors to increase the rate at which video clips are produced and assembled into a second video segment. In embodiments, the video segment comprises a picture-in-picture display. The picture-in-picture display can be used to show the ecommerce purchase environment at the same time the synthetic human is shown performing the LLM response. The picture-in-picture display can be used to show product demonstrations, a 3D image of a product that can be manipulated by the user, an image of the user wearing the clothing or accessory being considered, a suggested arrangement of furniture in a room, and so on, on a portion of the interactive screen along with the synthetic human performing the LLM response.

The flow 100 includes responding 170, by the synthetic human, to the inquiry, wherein the responding includes the video segment, and wherein the responding includes performing 180, by the IVF, the one or more skills that were selected. The IVF can display the assembled video segment performed by the synthetic human on the interactive screen. In embodiments, the user can continue to interact with the synthetic human, generating additional input collected by the IVF. The collecting user input, creating a response, producing audio segments and related video clips, and presenting to the user continues, so that the interaction between the user and the synthetic human appears as natural as two humans interacting within a video chat. Embodiments include storing, in a library, the user response to the interaction. Storing the response can ensure that the response can be used by the LLM for additional learning and accuracy. The library can comprise various media types, including video, text, audio, pictures, and so on. The library can be online. Further, storing the response can allow a faster response to a similar question with similar user signals in the future. The response can be used for a different user. In this case, a semantic search classifier can search a library of previous responses to be sent, by the router, to an appropriate module.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

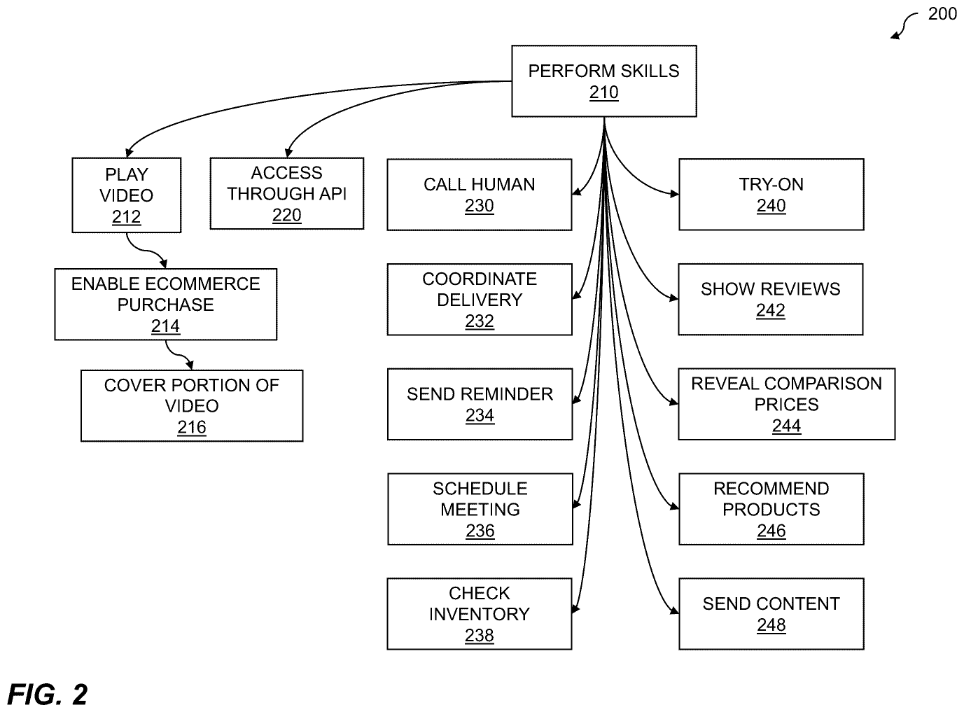

FIG. 2 is a flow diagram for performing an action. The flow 200 includes performing 210, by the IVF, the one or more skills that can be selected by the LLM as part of creating a response to a user inquiry. In embodiments, the one or more skills are accessed through an API 220, wherein the API executes a web service. The web services can include ecommerce purchase environments, centralized warehouse inventory searches, shipping options, and so on. In embodiments, one or more lightweight LLMs can be included in the IVF. The one or more lightweight LLMs can be used to classify the user intention for initiating an interaction with the IVF. Once the user's intention is known, additional classifying can be performed. The IVF can include an additional LLM. The additional classifying can include a knowledge tree. The knowledge tree can be based on the one or more products for sale and can include information that the additional LLM, which can be a heavy LLM, can use to generate a relevant response to the user. The knowledge tree can include information needed for any number of products, and various paths through the tree can represent information needed for different products. For example, a user can ask for a shoe recommendation while the classifying can indicate an intention of the user to purchase a product. A heavy LLM can then use a “shoe path” in the knowledge tree to determine what additional information is needed to make a shoe recommendation to the user. This information can include size, style preferences, men's or women's fashion, type of shoe, and so on. In embodiments, the LLM can select one or more skills related to the selected knowledge tree. For example, the “shoe path” can include skills for checking the store inventory for shoes matching the size of the user. The skills can include a virtual try-on of the shoes based on a full-body scan of the user taken by the video camera in the IVF. The skills can include calling a salesperson to the IVF to help the user try on shoes. The skills can include completing a purchase of the shoes, and so on.

In embodiments, the one or more skills include a checkout function. The checkout function can be included in an ecommerce purchase environment included in the IVF or accessed through an API 220. The one or more skills can include playing 212 a short-form video relevant to the product for sale. The playing a short-form video can include enabling an ecommerce purchase 214 of the product for sale. The ecommerce purchase can include a representation of the product for sale in an on-screen product card. The enabling the ecommerce purchase can include a virtual purchase cart. The virtual purchase cart can cover 216 a portion of the short-form video. In embodiments, the enabling can include a representation of the product for sale in an on-screen product card. In other embodiments, the enabling the ecommerce purchase includes a virtual purchase cart. The ecommerce purchase can include showing, within a short-form video or livestream, the virtual purchase cart. In embodiments, the virtual purchase cart covers a portion of the video segment. The synthetic human can demonstrate, endorse, recommend, and otherwise interact with the product for sale. An ecommerce purchase of at least one product for sale can be enabled to the viewer, wherein the ecommerce purchase is accomplished within the interactive screen. As the synthetic human interacts with and presents the product for sale, a product card representing one or more products for sale can be included within a video shopping window. An ecommerce environment associated with the video segment can be generated on the interactive screen as the rendering of the video progresses. The ecommerce environment on the interactive screen can display a livestream or other video event and the ecommerce environment at the same time. While the user is interacting with the product card, the second video segment can continue to play. Purchase details of the product for sale can be revealed, wherein the revealing is rendered to the viewer. The viewer can purchase the product through the ecommerce environment, including a virtual purchase cart. The viewer can purchase the product without having to expand the interactive screen purchase session or pause the second video segment. The second video segment can continue to play while the viewer is engaged with the ecommerce purchase. Additional video segments, comprising additional interactions, can play while the product card remains revealed. In embodiments, the video segment can continue beside, above, or below the ecommerce purchase window, where the virtual purchase window can obscure or partially obscure the livestream event. In some embodiments, the synthesized video segment can display the virtual product cart while the synthesized video segment plays. The virtual product cart can cover a portion of the synthesized video segment while it plays.

In embodiments, the one or more skills include calling 230 a human for help. The IVF can be connected to the store point-of-sale system, mobile phones, or tablets used by store salespeople. The IVF can include a light or other visible indicator that can notify store salespeople that a user needs assistance, and so on. In embodiments, the one or more skills include coordinating 232 a delivery. The IVF can access a warehouse inventory system to select items purchased by the user and forward the information to an internal or external shipping agent or application. In embodiments, the one or more skills include sending 234 a reminder. The IVF can assess user information including mobile phone numbers, email addresses, landline numbers, and so on. If the required user information is not already stored in the LLM, the information can be acquired from the user using text input through the interactive screen or spoken verbally and detected by the one or more microphones included in the IVF. The reminder can be set up to notify a user of an appointment, a scheduled date to take delivery of a purchase, a call-back to view a car being shipped from another dealer, and so on. In embodiments, the one or more skills include scheduling 236 a meeting. The IVF can present a calendar with pre-arranged time slots for reserving a table for dinner, selecting a doctor's appointment, scheduling a job interview, scheduling a meeting with a store manager, and so on. In some embodiments, the IVF can interface with a user's online calendar or send a formatted appointment file to the user's email address, computer, mobile device, etc. In embodiments, the one or more skills include checking 238 an inventory for the product for sale. The inventory can be based on the local store or can also include related stores in the area. The inventory can include products stored in regional or national warehouses.

In embodiments, the one or more skills include a virtual 240 try-on. The IVF can scan the user and generate a 3D model that can be used to generate a video segment in which the user wears an article of clothing or an accessory for sale in the store. In some embodiments, a game engine can be used to generate a series of animated movements, including basic actions such as sitting, standing, turning side to side, holding a product, and so on. Specialized movements can be programmed and added to the animation as needed, including pushing a vacuum cleaner, driving a car, playing an instrument, and so on. The user can be displayed in the virtual try-on while the synthetic human is displayed in a picture-in-picture interface. In embodiments, the one or more skills include showing 242 one or more reviews of the product for sale. The IVF can access video segments from a vendor or manufacturer, from a social media platform, and so on. The video segments can be produced by salespeople, product experts, social media influencers, product users, and so on. In embodiments, the one or more skills include revealing 244 one or more comparison prices of the product for sale. The IVF can access websites of competitors selling the same products, manufacturer sites including recommended prices, and so on. In embodiments, the one or more skills include recommending 246 one or more other products, wherein the one or more other products are based on the inquiry. The IVF can access similar products made by the same vendor as the product being considered by the user, as well as products made by other vendors for sale in the store. In some embodiments, the IVF can access information about products sold in other stores.

In embodiments, the one or more skills include sending content 248 to the user, wherein the content is related to the inquiry. The content can include a shopping list. The content can include a recipe. The content can include a video. The IVF can access email addresses, mobile phone numbers, etc., and can send messages that include links to websites, social media platforms, vendor sites, and so on that store content related to products for sale in the store. In some embodiments, the messages can include embedded videos, along with links to a store website or social media platform enabling the purchase of items in which the user has shown an interest. The content can be related to the product for sale, for example, to give the user ideas on how to use the product, or the content can be unrelated to the product for sale.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

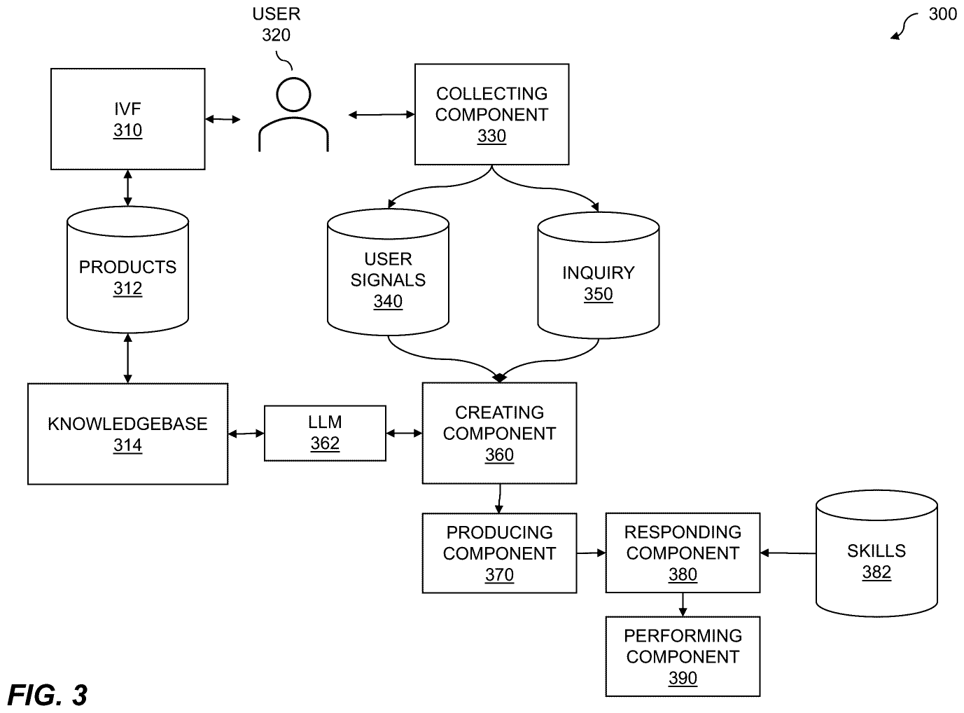

FIG. 3 is an infographic for an artificial intelligence virtual assistant in a physical store. The infographic 300 includes accessing, by a user 320, an interactive video interface (IVF) 310, wherein the IVF includes a video camera and an interactive screen, wherein the IVF includes a synthetic human, and wherein the IVF is located in a physical store. In embodiments, the IVF includes a microphone. The interactive screen can comprise a touchscreen. The IVF can be a free-standing structure or can be attached to a wall included in the physical store. In some embodiments, a digital keyboard can be displayed on the interactive screen, as well as screen hotspots to initiate an interaction. Stylus pens can be included to accommodate customers who prefer not to touch the interactive screen directly. In some embodiments, the ability to collect cash payments and provide change can be included. Magnetic card readers for ATM and credit card purchases, as well as a scanner for RFID transactions, can also be included.

In embodiments, the synthetic human can be based on an image of a live human. The synthetic human can be based on images captured from media sources including one or more photographs, videos, livestream events, and livestream replays. The voice of a human can be recorded and included in the synthetic human. The synthetic human can include a synthesized voice. In some embodiments, the appearance of the synthetic human can be customized, based on user information collected by the IVF. Elements of user demographic data, including sex, age, race, and so on, can be used to select and customize the appearance of the synthetic human. The synthetic human can be chosen to encourage the user to interact with the synthetic human and to be open to purchase products that are presented and discussed during the interaction. The customizing can include age, sex, race, hair color and style, clothing, accessories, facial hair, eyewear, and so on. In embodiments, the voice of the synthetic human can be customized, including the tone, pitch, accent, rhythm, and idioms. In some embodiments, the IVF customizes the voice and appearance of the synthetic human based on previous interactions with human and synthetic hosts of livestreams, sales associates, frequently watched social media influencers, and so on, as well as the demographics of the user.

The infographic 300 includes a collecting component 330. The collecting component 330 can include collecting, by the IVF 310, user input, wherein the user input comprises an inquiry 350, wherein the inquiry is based on a product 312 for sale. In embodiments, the inquiry is based on one or more additional products for sale. The user 320 inquiry can comprise text. The user can respond to the synthetic human by typing a question or comment into a chat text box displayed on the interactive screen. The text box can be generated by the IVF. The user input can comprise audio input. The audio input can include speaking into one or more microphones included in the IVF. The audio input can be analyzed to collect one or more user signals. The collecting component 330 can further comprise transforming the audio input into text, wherein the transforming is accomplished with a speech-to-text converter. The user input can comprise video input. The video input can be collected by the webcam included in the IVF. The video input can be analyzed to collect one or more user signals. The video input can include audio input which can be analyzed, recorded, and/or transformed by a speech-to-text converter.

In embodiments, the collecting includes one or more user signals 340. The user signals can be based on a video capture of the user. The user signals can be based on an audio capture of the user. In embodiments, the one or more user signals can include information from the store hosting the IVF. The one or more user signals can include various information about the user which can be helpful in creating a response to the user input. In embodiments, the one or more user signals include a tone of the user. The tone of the user can be detected from a voice or video of the user that was captured. The tone can comprise a sentiment. For example, wild hand movements and/or an elevated voice can be an indication of an angry tone or sentiment. This can guide the LLM, which can be a heavy LLM, in generating a response that is helpful to calm the user. In other embodiments, the one or more user signals include demographic data of the user. Demographic information can help an LLM to generate relevant responses. For example, knowing the gender of a user can direct the LLM to create a response that can be more relevant. In other embodiments, the one or more user signals include purchase history of the user. Knowing what a user has purchased in the past can help an LLM to generate other relevant product recommendations for the user. In further embodiments, the one or more user signals include a video or picture of the user. A video or picture of the user can indicate a mood, tone, sentiment, and so on of the user. This information can also provide other information such as clothing, jewelry, makeup and so on that the user is wearing. These signals can also be helpful in generating a response to the user's input. LLM models have been known to hallucinate. When an LLM mode hallucinates, it can generate irrelevant answers to questions asked or data provided. Thus, in embodiments, the one or more user signals include the probability of introducing, by one or more classifiers, a hallucination.

The probability of hallucination can depend on the answerability of the user input. For example, user input can include a question for which there is a straightforward right or wrong answer. In this case, the probability of hallucination can be low. This can be due to a low setting in a tolerance level. However, the user input can include a multi-category question, or the user can be seeking general advice. In these situations, the probability of hallucinating can be higher. In addition, the probability of hallucination can be higher when information regarding the one or more products is lacking. Embodiments can include setting a hallucination tolerance level. This can limit the impact of a hallucination. The tolerance level can prevent an incorrect answer by the LLM. For example, if the user input comprises a question about medical advice, the hallucination tolerance level can be set extremely low. The low setting may prevent the

LLM from answering the question and instead can trigger an action such as alerting a human.

In embodiments, the collecting includes classifying, by one or more lightweight LLMs, the user input, wherein the classifying identifies a type of conversation, wherein the classifying is based on the collecting, and wherein the responding is based on the type of conversation. In embodiments, the LLM can be trained with voice and text interactions between users, human sales associates, help desk staff members, product experts, and Al virtual assistants. Information articles and questions covering products (and services) offered for sale by the store can be included in the LLM knowledgebase 314. A knowledgebase is a centralized collection of information about a specific topic or entity. In embodiments, the knowledgebase contains information related to products and services offered by a physical store or group of stores. The knowledgebase can hold any type of information related to the products and services offered by the store. The data can be structured text, unstructured text, documents, videos, service or user manuals, sales fliers, brochures, short-form videos, video clips from websites, and so on. The information on products in the knowledgebase can be analyzed by the LLM and can be used to generate answers to questions and comments related to products and services offered for sale.

The infographic 300 includes a creating component 360. The creating component 360 can include creating a response, by the IVF 310, wherein the response is based on a large language model (LLM) 362, and wherein the response includes selecting, by the LLM, one or more skills 382, wherein the selecting is based on the creating. In embodiments the infographic 300 further comprises training the LLM 362, wherein the training is based on a private knowledgebase 314, wherein the private knowledgebase includes a plurality of details about the product for sale. The product and service data 312 can reside in a knowledgebase 314 that is accessible and updatable by a seller of the product or service. Additional training data can be provided by product vendor sites, product expert videos, marketing and advertising materials, sales staff input, and so on. Previous user interactions can also be included in the LLM training data, so that the LLM responses become increasingly tailored to the needs of the users. In embodiments, the conversation module selected by the router can include all user input signals including the kind of information being sought and the general attitude of the user. The user information can be analyzed by the LLM to generate a response to the user that addresses both the emotional tone and the information-based aspects of the conversation between the user and synthetic human host. In embodiments, the LLM response can be a text file that includes instructions for the video production step as well as the words to be spoken by the synthetic human. In embodiments, the skills included in the IVF can be used to conduct tasks related to the user inquiry classified by the LLM. The skills can be accessed through an application programming interface (API), wherein the A PI executes a web service. As mentioned throughout, the skills can include initiating an ecommerce purchase, completing a purchase checkout, coordinating a delivery, sending a reminder, recommending related products, and so on.

The infographic 300 includes a producing component 370. The producing component 370 includes producing a video segment, wherein the video segment is based on the response, and wherein the video segment includes an animated performance by the synthetic human. In embodiments, the text of the response to the user generated by the LLM is used to create a set of video clips including the synthesized human performing the response and related skills 382. The text response to the user can be used to create an audio stream using the voice of the synthesized human used in the first response to the user. The audio stream can be separated into smaller segments based on natural language processing (NLP) analysis. Each audio segment can be used to produce a video clip of the synthesized human performing the audio segment. Based on the content of the audio, the synthesized human can hold up and demonstrate a product, show the product at different angles, describe various ways of using the product, place the product on the synthetic head or body, and so on. The audio segments can be sent to multiple processors to increase the rate at which video clips are produced and assembled into a second video segment. In embodiments, the video segment comprises a picture-in-picture display. The picture-in-picture display can be used to show the ecommerce purchase environment at the same time the synthetic human is shown performing the LLM response. The picture-in-picture display can be used to show product demonstrations, a 3D image of a product that can be manipulated by the user, an image of the user wearing the clothing or accessory being considered, a suggested arrangement of furniture in a room, and so on, on a portion of the interactive screen along with the synthetic human performing the LLM response.

The infographic 300 includes a responding component 380. The responding component 380 includes responding, by the synthetic human, to the inquiry 350, wherein the responding includes the video segment, and wherein the responding includes performing 390, by the IVF, the one or more skills that were selected. In embodiments, the video segment including the selected skills 382 is performed by the IVF 310. In embodiments, the user can continue to interact with the synthetic human, generating additional input collected by the IVF. The collecting user input, creating a response, producing audio segments and related video clips, and presenting to the user continues, so that the interaction between the user and the synthetic human appears as natural as two humans interacting within a video chat. Embodiments include storing, in a library, the user response to the interaction. Storing the response can ensure that the response can be used by the LLM for additional learning and accuracy. The library can comprise various media types, including video, text, audio, pictures, and so on. The library can be online. Further, storing the response can allow a faster response to a similar question with similar user signals in the future. The response can be used for a different user. In this case, a semantic search classifier can search a library of previous responses to be sent, by the router, to an appropriate module.

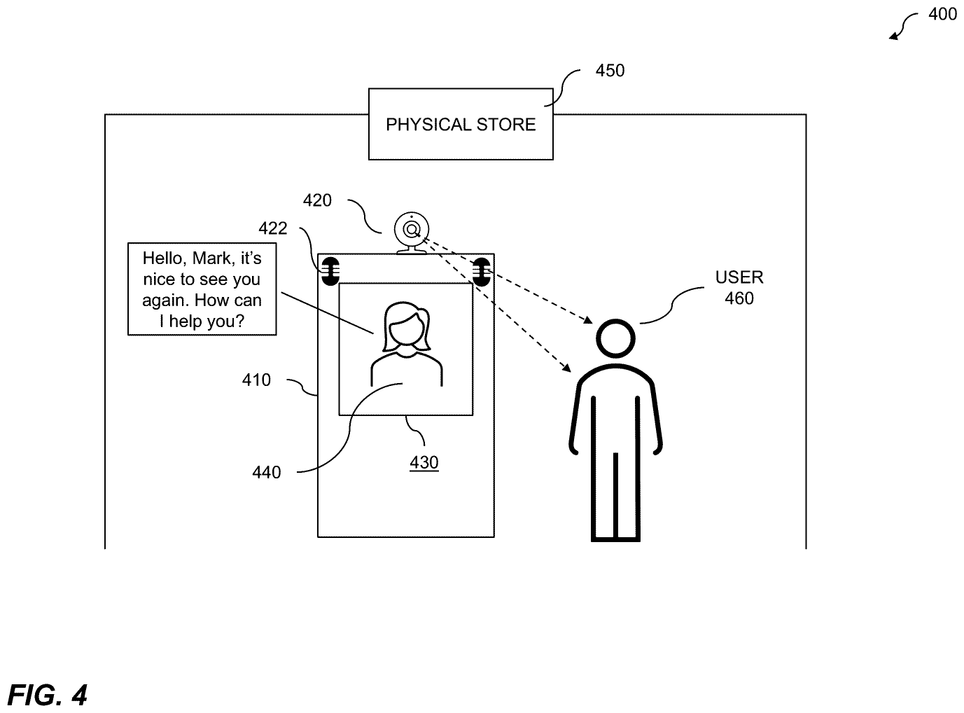

FIG. 4 is an infographic for initiating an interaction. The infographic 400 includes initiating, by the user 460, an interaction with the IVF 410. As described throughout, the interactive video interface (IVF) is located in a physical store 450 and includes a video camera 420, an interactive screen 430, and one or more microphones 422. In embodiments, the interactive screen comprises a touchscreen. The IVF includes a synthetic human 440 that can interact with a user 460 in the physical store. In embodiments, the initiating includes standing, by the user, within a minimum distance from the IVF. The video camera 420 included in the IVF can recognize humans when they stand a minimum distance away from the front of the IVF video camera. The minimum distance can be six inches, twelve inches, or any other distance. In some embodiments, the minimum and maximum distances used by the video camera can be set by store operators. In embodiments, the initiating can be accomplished by a user touching the interactive screen. The screen can include specific locations on the screen that are marked, such as “Touch here to speak with a representative” or “Type in your name to begin,” etc. In some embodiments, the screen can be set so that a user touching the screen in any location can start an interaction. In embodiments, the user can initiate an interaction by speaking to the IVF. The IVF can be adjusted by the store operators to listen for specific words or phrases, such as “Please tell me about this shoe” or “I would like to try this boot on,” etc. The IVF can be trained to recognize a name assigned to the synthetic human, so that when a user says, “Hello, Alice,” the IVF responds with a welcome video including the matching synthetic human.

The infographic 400 includes recognizing the user 460. In embodiments, the recognizing can be based on the video camera 420. The LLM can include stored images of users that can be compared to images captured by the video camera. The recognizing can be based on data entered by the user on the interactive screen. The user can enter a username and password by typing the information into a physical keyboard or a digital keyboard displayed on the interactive screen. The recognizing can include scanning an identification card. The identification card can include a barcode, an RFID chip, a magnetic strip, and so on. The recognizing can include performing, by the IVF, facial recognition on the user. Facial recognition identifies human faces by analyzing their facial features. It uses biometrics and artificial intelligence (AI) to map these features from photographs or videos and then compares the information with a database of known faces to find a match. The recognizing can include performing, by the IVF, voice recognition on the user, wherein the IVF includes a microphone 422. The LLM can include stored Mel spectrogram data for store customers. The stored Mel spectrogram data can be compared to audio data detected by the IVF microphone and used to associate a user speaking to the IVF to customer voice data stored in its knowledgebase. In embodiments, the recognizing can include a purchase history. The recognizing can include one or more previous interactions with the IVF. The recognizing can further comprise remembering, by the IVF, a name of the user, wherein the name was saved in a previous inquiry. The recognizing can include preferred payment details, shipping addresses, clothing sizes, owned vehicle information, tire sizes, etc. based on information collected by the store as part of previous purchases or interactions.

The infographic 400 includes displaying, on the IVF interactive screen, a first video segment, wherein the first video segment includes a synthetic human 440. In embodiments, the first video segment can display a synthetic human initiating a response to the user interaction request. The first video segment can include user details from the LLM knowledgebase, based on the recognition of the user. For example, the synthetic host can say “Hello, Mark, it's nice to see you again. How can I help you?” In cases where the user has asked for help from a specific product webpage, the initial synthetic human interaction can be more specific. For example, “Hello, Mark. I see that you are looking at our universal cooking pot. What questions can I answer for you?” The synthetic human can be based on an image of a live human. The synthetic human can be based on images captured from media sources including one or more photographs, videos, livestream events, and livestream replays. The voice of a human can be recorded and included in the synthetic human. The synthetic human can include a synthesized voice.

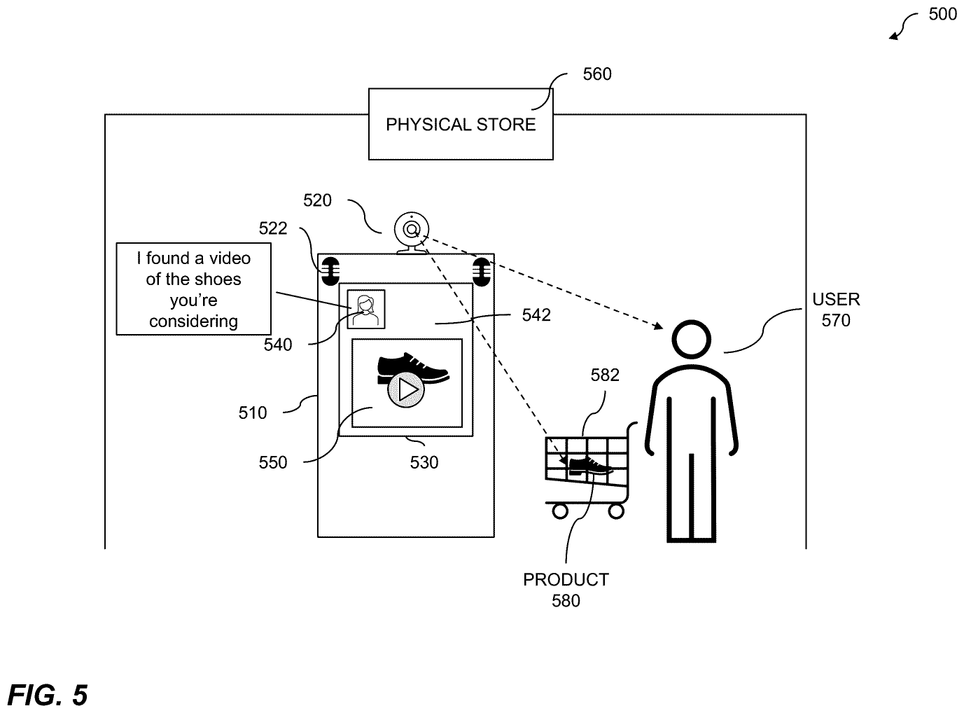

FIG. 5 is an infographic for playing a short-form video. As described throughout, the infographic 500 includes an interactive video interface (IVF) 510 located in a physical store 560. The IVF includes a video camera 520 and an interactive screen 530. The IVF can include one or more microphones 522. In embodiments, the interactive screen comprises a touchscreen. The IVF includes a synthetic human 540 that can interact with a user 570 in the physical store. In embodiments, the initiating includes standing, by the user, within a minimum distance from the IVF. The video camera 520 included in the IVF can recognize humans and other objects when they are a minimum distance away. In embodiments, the minimum distance is six inches. The minimum distance can be eight inches, twelve inches, or any other distance from the front of the IVF video camera. In some embodiments, the minimum and maximum distances used by the video camera can be set by store operators.

In embodiments, the IVF includes a product knowledgebase. The one or more LLMs included in the IVF can be trained with voice and text interactions between users, human sales associates, help desk staff members, product experts, and AI virtual assistants. Information articles and questions covering products and services offered for sale by the website can be included in the LLM knowledgebase. A knowledgebase is a centralized collection of information about a specific topic or entity. In embodiments, the knowledgebase contains information related to products and services offered by a website or sales application. The knowledgebase can hold any type of information related to the products and services offered by the website. The data can be structured text, unstructured text, documents, images, videos, service or user manuals, sales fliers, brochures, short-form videos, video clips from websites, and so on. The information on products in the knowledgebase can be analyzed by the LLM and used to generate answers to questions and comments related to products and services offered for sale.

The infographic 500 further comprises recognizing, by the IVF, a product 580 for sale. In embodiments, the product can be held or carried by a user 570. The product can be placed in a shopping cart 582, carried under an arm, held in the user's hands, etc. The recognizing can be based on the video camera. The LLM can include stored images of products that can be compared to images captured by the video camera. In embodiments, the recognizing is based on video recognition. In embodiments, the recognizing can be based on data entered by the user on the interactive screen. The user can enter a product name or item number by typing the information into a physical keyboard or a digital keyboard displayed on the interactive screen. The recognizing can be based on a universal product code (UPC) scanner. The UPC scanner can be included in the IVF and can exchange data with the IVF using Wi-Fi, Bluetooth, or a wired link to the IVF. In embodiments, the user can verbally speak the name of the product to the IVF. The microphone included in the IVF can capture the audio signals produced by the user and convert them to text. The LLM can use the text from the audio file to identify the product named by the user.

The infographic 500 includes producing a video segment, wherein the video segment is based on the response, and wherein the video segment includes an animated performance by the synthetic human 540. In embodiments, the text of the response to the user generated by the LLM is used to create a set of video clips including the synthesized human performing the response. The text response to the user can be used to create an audio stream using the voice of the synthesized human used in the first response to the user. The audio stream can be separated into smaller segments based on natural language processing (NLP) analysis. Each audio segment can be used to produce a video clip of the synthesized human performing the audio segment. In the infographic 500, the synthetic human 540 says, “I found a video of the shoes you're considering.” Based on the content of the audio, the synthesized human can hold up and demonstrate a product, show the product at different angles, describe various ways of using the product, place the product on the synthetic head or body, and so on. The audio segments can be sent to multiple processors to increase the rate at which video clips are produced and assembled into a second video segment. In embodiments, the video segment comprises a picture-in-picture display 542. The picture-in-picture display can be used to show the ecommerce purchase environment at the same time the synthetic human is shown performing the LLM response. The picture-in-picture display can be used to show a video 550 of the product for sale, a product demonstration, a 3D image of a product that can be manipulated by the user, an image of the user wearing the clothing or accessory being considered, a suggested arrangement of furniture in a room, and so on, on a portion of the interactive screen along with the synthetic human performing the LLM response 540 in the picture-in-picture display 542.

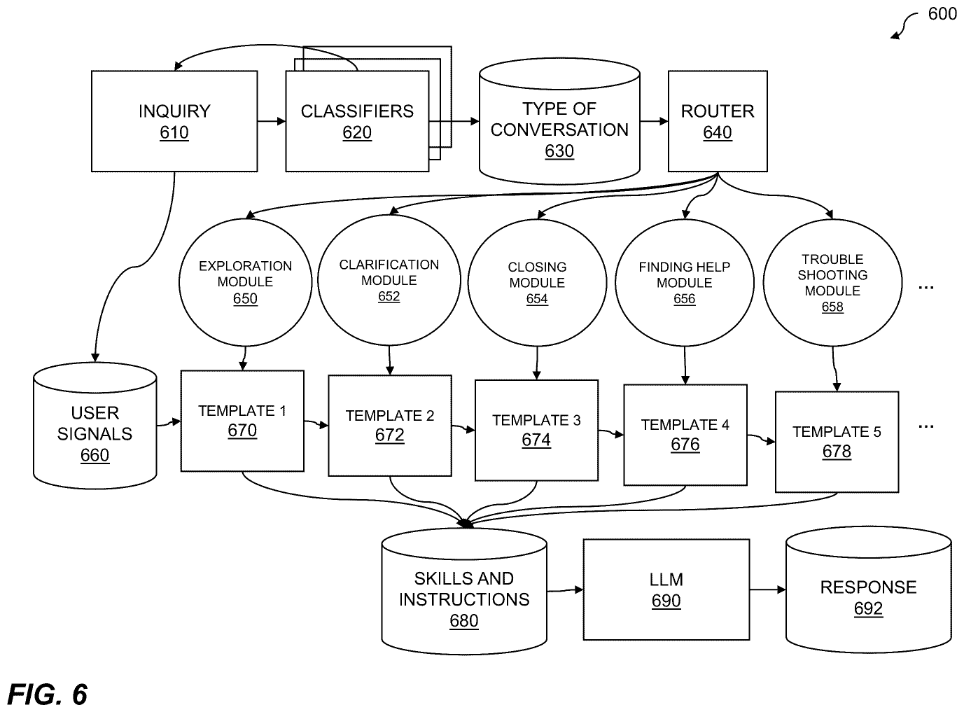

FIG. 6 is an infographic for providing instructions. The infographic 600 includes classifying, by one or more classifiers 620, the user input, wherein the one or more classifiers operate in parallel, wherein the classifying identifies a type of conversation 630, and wherein the classifying is based on the collecting. In embodiments, the user input including the user inquiry 610 being classified can be collected by an interactive video interface (IVF). As described throughout, the one or more classifiers can comprise one or more LLMs, one or more semantic searches, one or more other types of classifiers, or any combination thereof. The classifiers can be trained with voice and text interactions between users, human sales associates, help desk staff members, product experts, and Al virtual assistants.

In embodiments, the classifiers 620 can analyze and classify the user input, including the inquiry 610 between the user and the synthetic human, to identify the type of conversation 630. The user input can be analyzed to extract one or more user signals 660. As mentioned above, the user signals can include emotions and gestures of the user, purchase information, shipping information, demographics, and so on. Depending on the type of store, the services, and the products being offered, user interactions can take many different forms with one or more agendas. The attitude of the user can vary. Users can be calm or agitated, happy or angry, highly emotional and demonstrative, or at ease. These factors can be collected by the embedded interface and forwarded to the one or more classifiers for analysis. The classifiers 620 can include the user signals along with the text of the user responses to classify the conversation. The classification information can be included in decisions regarding how to manage the user conversation in later steps.

The infographic 600 includes routing 640 the user input, by a controller, to one or more modules, wherein the routing is based on the classifying, and wherein the one or more modules provide skills and instructions 680 to an LLM 690. In embodiments, the LLM is a heavy LLM. In the infographic 600, the one or more modules include an exploration module 650. The one or more modules include a clarification module 652. The one or more modules include a closing module 654. The one or more modules include a finding help module 656. The one or more modules include a troubleshooting module 658. Other modules, such as an advisory module, can be included. Each module can be used to select skills and create instructions which can be used by the LLM 690 so that responses generated by the LLM provide the user the information they are requesting and address the emotional content of the conversation. The modules can include acknowledgements of a user's anger or frustration, joy, or sorrow, and can express words of sympathy or camaraderie along with information about the product or service under discussion in order to move a conversation forward and provide useful direction for the customer.

In embodiments, the selecting skills and providing instructions are based on one or more templates. The example 600 includes template 1 670 for exploration module 650, template 2 672 for clarification module 652, template 3 674 for closing module 654, template 4 676 for finding help module 656, and template 5 678 for troubleshooting module 658. Additional templates can be used for other modules based on user input collected by the embedded interface. In embodiments, the template can include a markup language. The template used to provide instructions for the LLM can have a defined structure based on a markup language. The markup language template can include tags for various user signals, such as the age or sex of the user, information about the most recent purchase made by the user, the tone of the user's language in the conversation, and so on. The selecting skills and providing instructions can further comprise programming the template, wherein the programming is based on the markup language. The programming can include combining the collected user signals with the instructions template to produce a set of instructions and skills specific to the conversation between a user and the synthetic human.

In embodiments, the selecting skills and providing instructions can further comprise selecting a template from a plurality of templates, wherein the selecting is based on the routing 640. The user data collected and analyzed by the one or more classifiers 620 can be used to select a template that best matches the conversation between the user and synthetic human. The providing instructions can further comprise sending one or more user signals 660 to the template, wherein the sending is based on the markup language. Once a conversation template is selected, the user signals collected by the interactive video interface can be added to the template to produce a tailored set of instructions and skills 680 for the LLM 690 to use in generating a response 692 to the user.

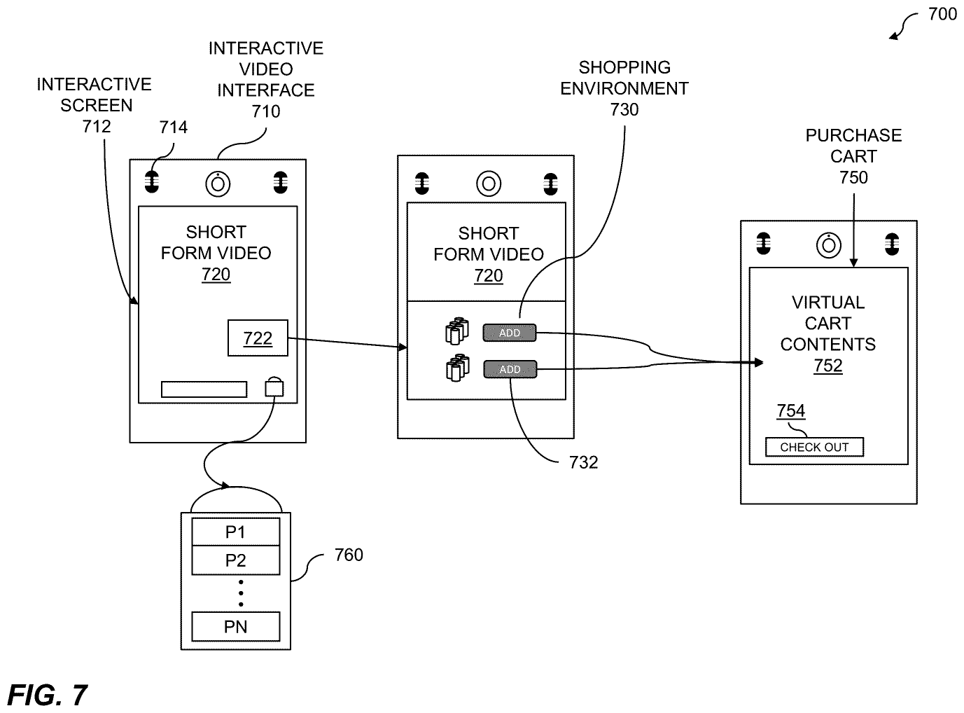

FIG. 7 is an example of an ecommerce purchase. As described above and throughout, a user can interact with an interactive video interface (IVF) regarding items for sale. The example 700 shows an interaction on an interactive screen 712. The interactive screen can be included on the IVF 710. The IVF 710 can include a video camera and an interactive screen. The IVF can include one or more microphones 714. The IVF can be located in a physical store. The interaction can include one or more answers generated by the LLM which can be produced into one or more video segments displayed. During the interaction, a first video segment, second video segment, and other video segments can be streamed to the user. In embodiments, the streaming of any of the video segments comprises a short-form video. The short-from video 720 can include a separate window that demonstrates a product for sale while the artificial intelligence artificial assistant, which can comprise one or more streamed video segments, is shown in the interactive screen. In embodiments, the short-form video can be viewed in real time or replayed at a later time. In embodiments, the accessing the short-form video on the IVF via the interactive screen can be accomplished using a microphone and/or a video camera, by scanning an identification card, and so on.

The example 700 can include generating and revealing a product card 722 on the IVF 710. In embodiments, the product card represents at least one product available for purchase while the short-form video plays. Embodiments can include inserting a representation of the first object into the on-screen product card. A product card is a graphical element such as an icon, thumbnail picture, thumbnail video, symbol, or other suitable element that is displayed in front of the short-form video. The product card can be selectable via a user interface action such as a press, swipe, gesture, mouse click, verbal utterance, or other suitable user action. The product card 722 can be inserted when the short-form video is visible 720. When the product card is invoked, an in-frame shopping environment 730 can be rendered over a portion of the short-form video while the short-form video continues to play. This rendering enables an ecommerce purchase 732 by a user while preserving a continuous short-form video playback session. In other words, the user is not redirected to another website or portal that causes the short-form video playback to stop. Thus, viewers are able to initiate and complete a purchase completely inside of the short-form video playback user interface, without being directed away from the currently playing short-form video. Allowing the short-form video event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The example 700 can include rendering an in-frame shopping environment 730. The rendering can enable a purchase of the at least one product for sale by the viewer, wherein the ecommerce purchase is accomplished within the short-form video window. The short-form video window can be enabled by the interactive screen 712. In embodiments, the short-form video window can include a real time short-form video, a prerecorded short-form video segment, a livestream, a livestream replay, one or more video segments comprising an answer from an artificial intelligence virtual assistant, and so on. The short-form window can include any combination of the aforementioned options. The enabling can include revealing a virtual purchase cart 750 that supports checkout 754 of virtual cart contents 752, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 760 are purchased via product cards during the short-form video, the purchases are cached until termination of the short-form video, at which point the orders are processed as a batch. The termination of the short-form video can include the user stopping playback, the user exiting the video window, the short-form video ending, or a prerecorded short-form video ending. The batch order process can enable a more efficient use of computer resources, such as network bandwidth, by processing the orders together as a batch instead of processing each order individually.

Embodiments include enabling an ecommerce purchase of the one or more products for sale. The enabling can be accomplished within the short-form video. In other embodiments, the ecommerce purchase includes a representation of the one or more products for sale in an on-screen product card. In some embodiments, the enabling the ecommerce purchase includes a virtual purchase cart. In further embodiments, the virtual purchase cart covers a portion of the second video segment.

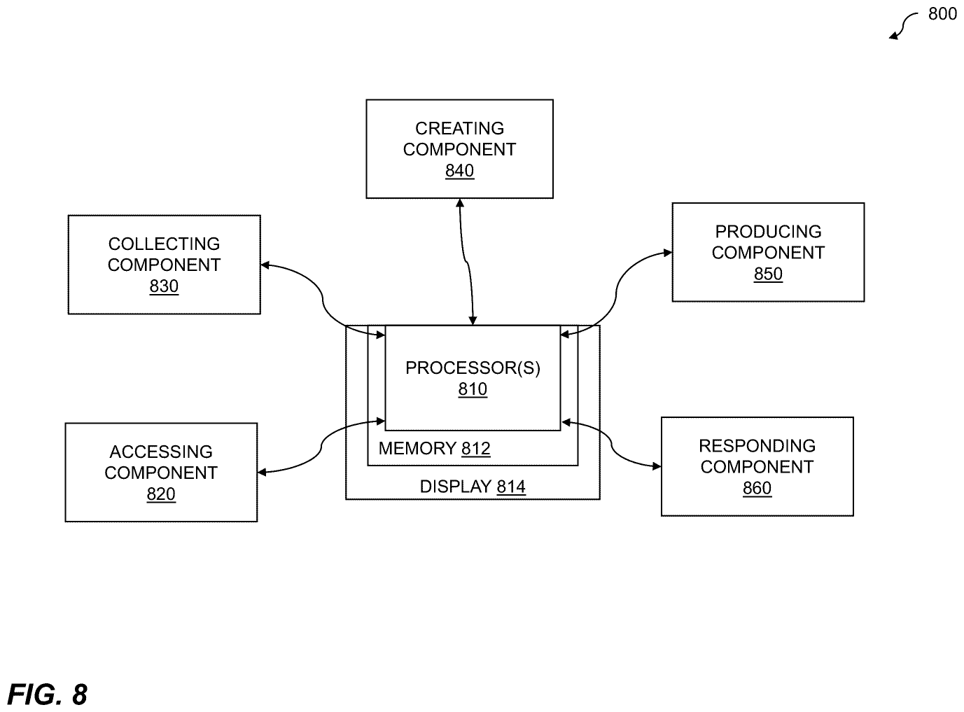

FIG. 8 is a system diagram for an artificial intelligence virtual assistant in a physical store. The system 800 can include one or more processors 810 coupled to a memory 812 which stores instructions. The system 800 can include a display 814 coupled to the one or more processors 810 for displaying data, video streams, videos, video metadata, synthesized images, synthesized image sequences, synthesized videos search results, sorted search results, search parameters, metadata, webpages, intermediate steps, instructions, and so on. In embodiments, one or more processors 810 are coupled to the memory 812 where the one or more processors, when executing the instructions which are stored, are configured to: access, by a user, an interactive video interface (IVF), wherein the IVF includes a video camera and an interactive screen, wherein the IVF includes a synthetic human, and wherein the IVF is located in a physical store; collect, by the IVF, user input, wherein the user input comprises an inquiry, wherein the inquiry is based on a product for sale; create a response, by the IVF, wherein the response is based on a large language model (LLM), and wherein the response includes selecting, by the LLM, one or more skills, wherein the selecting is based on the creating; produce a video segment, wherein the video segment is based on the response, and wherein the video segment includes an animated performance by the synthetic human; and respond, by the synthetic human, to the inquiry, wherein the responding includes the video segment, and wherein the responding includes performing, by the IVF, the one or more skills that were selected.

The system 800 includes an accessing component 820. The accessing component 820 includes functions and instructions for accessing, by a user, an interactive video interface (IVF), wherein the IVF includes a video camera and an interactive screen, wherein the IVF includes a synthetic human, and wherein the IVF is located in a physical store. In embodiments, the interactive screen comprises a touchscreen. The IVF can include a microphone. The IVF can be a free-standing structure or can be attached to a wall included in the physical store. In some embodiments, a digital keyboard can be displayed on the interactive screen, as well as screen hotspots, to initiate an interaction. In some embodiments, the ability to collect cash payments and provide change can be included.

In embodiments, the synthetic human can be based on an image of a live human. The synthetic human can be based on images captured from media sources including one or more photographs, videos, livestream events, and livestream replays. The voice of a human can be recorded and included in the synthetic human. The synthetic human can include a synthesized voice. In embodiments, the accessing further comprises training an LLM, wherein the training is based on a private knowledgebase, wherein the private knowledgebase includes a plurality of details about the product for sale. The LLM can be trained with voice and text interactions between users, human sales associates, help desk staff members, product experts, and Al virtual assistants. Information articles and questions covering products and services offered for sale by the store can be included in the LLM knowledgebase. The information on products in the knowledgebase can be analyzed by the LLM and used to generate answers to questions and comments related to products and services offered for sale. In embodiments, the accessing further comprises initiating, by the user, an interaction with the IVF. The initiating can include standing, by the user, within a minimum distance from the IVF. In some embodiments, the minimum distance can be six inches, nine inches, twelve inches, or any other distance. In embodiments, the minimum distance can be adjusted. The initiating can include recognizing the user. In embodiments, the recognizing can be based on the video camera. The recognizing can be based on audio files of the user speaking to the IVF. The recognizing can be based on information typed into the IVF interactive screen.

The system 800 includes a collecting component 830. The collecting component 830 includes functions and instructions for collecting, by the IVF, user input, wherein the user input comprises an inquiry, wherein the inquiry is based on a product for sale. In embodiments, the inquiry is based on one or more additional products for sale. The user input can comprise text. The user can respond to the synthetic human by typing a question or comment into a chat text box displayed on the interactive screen. The text box can be generated by the IVF. The user input can comprise audio input. The audio input can include speaking into one or more microphones included in the IVF. The audio input can be analyzed to collect one or more user signals. The collecting can further comprise transforming the audio input into text, wherein the transforming is accomplished with a speech-to-text converter. The user input can comprise video input. The video input can be collected by the webcam included in the IVF. The video input can be analyzed to collect one or more user signals. The video input can include audio input which can be analyzed, recorded, and/or transformed by a speech-to-text converter. User input can be forwarded to the one or more classifiers to determine the type of conversation the user wishes to have with the synthetic human. In practice, each classifier can search for a type of conversation in parallel so that all types of conversations can be identified concurrently, increasing the speed and accuracy of generating a response to the user.

The system 800 includes a creating component 840. The creating component 840 includes functions and instructions for creating a response, by the IVF, wherein the response is based on a large language model (LLM), and wherein the response includes selecting, by the LLM, one or more skills, wherein the selecting is based on the creating. In embodiments, the LLM can be trained on product and service data related to items sold by store including the IVF. The product and service data can reside in a knowledge database that is accessible and updatable by a seller of the product or service. Additional training data can be provided by product vendor sites, product expert videos, marketing and advertising materials, sales staff input, and so on. Previous user interactions can also be included in the LLM training data, so that the LLM responses become increasingly tailored to the needs of the users. In embodiments, the conversation module selected by the router can include all user input signals including the kind of information being sought and the general attitude of the user. The user information can be analyzed by the LLM to generate a response to the user that addresses both the emotional tone and the information-based aspects of the conversation between the user and synthetic human host. In embodiments, the LLM response can be a text file that includes instructions for the video production step as well as the words to be spoken by the synthetic human.

The system 800 includes a producing component 850. The producing component 850 includes functions and instructions for producing a video segment, wherein the video segment is based on the response, and wherein the video segment includes an animated performance by the synthetic human. In embodiments, the text of the response to the user generated by the LLM is used to create a set of video clips including the synthesized human performing the response. The text response to the user can be used to create an audio stream using the voice of the synthesized human used in the first response to the user. The audio stream can be separated into smaller segments based on natural language processing (NLP) analysis. Each audio segment can be used to produce a video clip of the synthesized human performing the audio segment. Based on the content of the audio, the synthesized human can hold up and demonstrate a product, show the product at different angles, describe various ways of using the product, place the product on the synthetic head or body, and so on. The audio segments can be sent to multiple processors to increase the rate at which video clips are produced and assembled into a second video segment. In embodiments, the video segment comprises a picture-in-picture display. The picture-in-picture display can be used to show the ecommerce purchase environment at the same time the synthetic human is shown performing the LLM response. The picture-in-picture display can be used to show product demonstrations, a 3D image of a product that can be manipulated by the user, an image of the user wearing the clothing or accessory being considered, a suggested arrangement of furniture in a room, and so on, on a portion of the interactive screen along with the synthetic human performing the LLM response.

The system 800 includes a responding component 860. The responding component 860 includes functions and instructions for responding, by the synthetic human, to the inquiry, wherein the responding includes the video segment, and wherein the responding includes performing, by the IVF, the one or more skills that were selected. In embodiments, the IVF can display the assembled video segment performed by the synthetic human on the interactive screen. The user can continue to interact with the synthetic human, generating additional input collected by the IVF. The collecting user input, creating a response, producing audio segments and related video clips, and presenting to the user continues, so that the interaction between the user and the synthetic human appears as natural as two humans interacting within a video chat. Embodiments include storing, in a library, the user response to the interaction. Storing the response can ensure that the response can be used by the LLM for additional learning and accuracy. The library can comprise various media types, including video, text, audio, pictures, and so on. The library can be online. Further, storing the response can allow a faster response to a similar question with similar user signals in the future. The response can be used for a different user. In this case, a semantic search classifier can search a library of previous responses to be sent, by the router, to an appropriate module.

The system 800 can include a computer program product embodied in a non-transitory computer readable medium for evaluation, the computer program product comprising code which causes one or more processors to perform operations of: accessing, by a user, an interactive video interface (IVF), wherein the IVF includes a video camera and an interactive screen, wherein the IVF includes a synthetic human, and wherein the IVF is located in a physical store; collecting, by the IVF, user input, wherein the user input comprises an inquiry, wherein the inquiry is based on a product for sale; creating a response, by the IVF, wherein the response is based on a large language model (LLM), and wherein the response includes selecting, by the LLM, one or more skills, wherein the selecting is based on the creating; producing a video segment, wherein the video segment is based on the response, and wherein the video segment includes an animated performance by the synthetic human; and responding, by the synthetic human, to the inquiry, wherein the responding includes the video segment, and wherein the responding includes performing, by the IVF, the one or more skills that were selected.

The system 800 can include a computer system for evaluation comprising: a memory which stores instructions; one or more processors coupled to the memory, wherein the one or more processors, when executing the instructions which are stored, are configured to: access, by a user, an interactive video interface (IVF), wherein the IVF includes a video camera and an interactive screen, wherein the IVF includes a synthetic human, and wherein the IVF is located in a physical store; collect, by the IVF, user input, wherein the user input comprises an inquiry, wherein the inquiry is based on a product for sale; create a response, by the IVF, wherein the response is based on a large language model (LLM), and wherein the response includes selecting, by the LLM, one or more skills, wherein the selecting is based on the creating; produce a video segment, wherein the video segment is based on the response, and wherein the video segment includes an animated performance by the synthetic human; and respond, by the synthetic human, to the inquiry, wherein the responding includes the video segment, and wherein the responding includes performing, by the IVF, the one or more skills that were selected.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”-may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video processing comprising:
accessing, by a user, an interactive video interface (IVF), wherein the IVF includes a video camera and an interactive screen, wherein the IVF includes a synthetic human, and wherein the IVF is located in a physical store;
collecting, by the IVF, user input, wherein the user input comprises an inquiry, wherein the inquiry is based on a product for sale;
creating a response, by the IVF, wherein the response is based on a large language model (LLM), and wherein the response includes selecting, by the LLM, one or more skills, wherein the selecting is based on the creating;
producing a video segment, wherein the video segment is based on the response, and wherein the video segment includes an animated performance by the synthetic human; and
responding, by the synthetic human, to the inquiry, wherein the responding includes the video segment, and wherein the responding includes performing, by the IVF, the one or more skills that were selected.

2. The method of claim 1 wherein the one or more skills include a checkout function.

3. The method of claim 1 wherein the one or more skills include playing a short-form video relevant to the product for sale.

4. The method of claim 3 wherein the playing a short-form video includes enabling an ecommerce purchase of the product for sale.

5. The method of claim 4 wherein the ecommerce purchase includes a representation of the product for sale in an on-screen product card.

6. The method of claim 5 wherein the enabling the ecommerce purchase includes a virtual purchase cart.

7. The method of claim 6 wherein the virtual purchase cart covers a portion of the short-form video.

8. The method of claim 1 wherein the one or more skills include calling a human for help, coordinating a delivery, sending a reminder, scheduling a meeting, or checking an inventory for the product for sale.

9. The method of claim 1 wherein the one or more skills include a virtual try-on.

10. The method of claim 1 wherein the one or more skills include showing one or more reviews of the product for sale.

11. The method of claim 1 wherein the one or more skills include revealing one or more comparison prices of the product for sale.

12. The method of claim 1 wherein the one or more skills include recommending one or more other products, wherein the one or more other products are based on the inquiry.

13. The method of claim 1 wherein the one or more skills include sending content to the user, wherein the content is related to the inquiry.

14. The method of claim 1 further comprising recognizing, by the IVF, the product for sale.

15. The method of claim 14 wherein the recognizing includes recognizing the user.

16. The method of claim 15 wherein the recognizing includes performing, by the IVF, voice recognition on the user, wherein the IVF includes a microphone.

17. The method of claim 15 wherein the recognizing includes a purchase history or previous interactions with the IVF.

18. The method of claim 1 further comprising initiating, by the user, an interaction with the IVF.

19. The method of claim 18 wherein the initiating includes standing, by the user, within a minimum distance from the IVF.

20. The method of claim 1 further comprising training the LLM, wherein the training is based on a private knowledgebase, wherein the private knowledgebase includes a plurality of details about the product for sale.

21. The method of claim 1 wherein the inquiry is based on one or more additional products for sale.

22. The method of claim 1 wherein the collecting includes classifying, by one or more lightweight LLMs, the user input, wherein the classifying identifies a type of conversation, wherein the classifying is based on the collecting, and wherein the responding is based on the type of conversation.

23. A computer program product embodied in a non-transitory computer readable medium for video processing, the computer program product comprising code which causes one or more processors to perform operations of:
accessing, by a user, an interactive video interface (IVF), wherein the IVF includes a video camera and an interactive screen, wherein the IVF includes a synthetic human, and wherein the IVF is located in a physical store;
collecting, by the IVF, user input, wherein the user input comprises an inquiry, wherein the inquiry is based on a product for sale;
creating a response, by the IVF, wherein the response is based on a large language model (LLM), and wherein the response includes selecting, by the LLM, one or more skills, wherein the selecting is based on the creating;
producing a video segment, wherein the video segment is based on the response, and wherein the video segment includes an animated performance by the synthetic human; and
responding, by the synthetic human, to the inquiry, wherein the responding includes the video segment, and wherein the responding includes performing, by the IVF, the one or more skills that were selected.

24. A computer system for video processing comprising:
a memory which stores instructions;
one or more processors coupled to the memory wherein the one or more processors, when executing the instructions which are stored, are configured to:
access, by a user, an interactive video interface (IVF), wherein the IVF includes a video camera and an interactive screen, wherein the IVF includes a synthetic human, and wherein the IVF is located in a physical store;
collect, by the IVF, user input, wherein the user input comprises an inquiry, wherein the inquiry is based on a product for sale;
create a response, by the IVF, wherein the response is based on a large language model (LLM), and wherein the response includes selecting, by the LLM, one or more skills, wherein the selecting is based on the creating;
produce a video segment, wherein the video segment is based on the response, and wherein the video segment includes an animated performance by the synthetic human; and
respond, by the synthetic human, to the inquiry, wherein the responding includes the video segment, and wherein the responding includes performing, by the IVF, the one or more skills that were selected.
